(19) United States
(12) Patent Application Publication
(10) Pub. No.: US 2009/0302666 A1
(43) Pub. Date: Dec. 10, 2009

(54) Laser Welding of Chair Components

(75) Inventors: Gregory Allison, Orefield, PA (US); Khalid Masoud, Souderton, PA (US); Adam Deskevich, Pennsburg, PA (US)

Correspondence Address: Buchanan Ingersoll Professional Corporation;One Oxford Centre, 301 Grant Street, 20th Floor, Pittsburgh, PA, 15219-1410, US

(73) Assignee: Knoll, Inc., East Greenville, PA (US)

(21) Appl. No.: 12/478,041

(22) Filed: Jun. 4, 2009

Related U.S. Application Data
(60) Provisional application No. 61/059,303, filed on Jun. 6, 2008.

(51) Int. Cl. A47C 5/12; A47C 7/02; B23K 26/20

(52) U.S. Cl. 297/463.1; 297/463.2; 219/121.64

(57) ABSTRACT

A method of laser welding chair components together is provided. The method includes selecting at least one first chair component comprised of a first polymeric material that is at least substantially translucent to a laser and selecting at least one second chair component comprised of a second polymeric material that is opaque to the laser such that the one or more second chair components will absorb at least a portion of the heat or energy provided by the laser. The one or more first chair components are laser welded to the one or more second chair components. A chair is also provided that includes a first component composed of polymeric material laser welded to a second component composed of polymeric material.

### CROSS-REFERENCE TO RELATED APPLICATION

The present application claims the benefit under 35 U.S.C. §119(e) of pending U.S. Provisional Patent Application Ser. No. 61/059,303, which was filed on June 6, 2008. The entirety of U.S. Provisional Patent Application Ser. No. 61/059,303 is incorporated herein by reference.

### FIELD OF THE INVENTION

The present invention relates to chairs and, more particularly, methods and mechanisms for fastening chair components together.

### BACKGROUND OF THE INVENTION

Chairs are formed by fastening multiple components to each other. Examples of chair components being attached together may be appreciated from U.S. Pat. Nos. 7,419,222, 6,957,863, 6,913,315, 6,817,667, 6,802,566, 6,726,285, 6,669,292, 6,439,665, 5,035,466 and 3,233,885.

Typically, chair components are fastened together by molding or over molding of components or by using fasteners such as bolts or screws, adhesives, interference fits between components, or a combination of the above. Such fastening mechanisms can provide holes or other aesthetic detractions from the design or appearance of a chair. This is particularly true for components that cannot be integrally molded together.

Other fastening mechanisms may require the use of a frame member or carrier member inserted into a channel or groove formed in a frame member. For instance, U.S. Pat. No. 6,386,634 and 6,540,950 disclose such fastening mechanisms, which are often used for fabric mesh back and seat components. Such fastening mechanisms require specific manufacturing tools and also require parts to be molded within certain tolerance ranges. For example, the groove or channels must be sized for receiving the carrier member. Such requirements increase the cost of manufacturing a chair and, in some instances, can complicate the assembly of the components.

A fastening method or fastening system is needed for fastening chair components together without detracting from a desired aesthetic effect of a chair or chair design. Preferably, the system or method can permit connections between components to connect the components without the use of fasteners such as bolts or screws or frame members insertable within grooves or channels in a frame member.

### SUMMARY OF THE INVENTION

A method of laser welding chair components is together is provided herein. The method includes selecting at least one first chair component comprised of a first polymeric material that s at least substantially translucent to a laser and selecting at least one second chair component comprised of a second polymeric material that is opaque to the laser such that the at least one second chair component will absorb at least a portion of heat or energy provided by the laser. The at least one first chair component can then be laser welded to the at least one second chair component.

Preferably, the one or more first and second chair components are configured such that the laser welding laser transmission rate is greater than 5% and, most preferably, is at least 25% to the at least one second chair component.

The first polymeric material may be the same material as the second polymeric material or may be different than the second polymeric material. For instance, the first polymeric material may be a first elastomeric material and the second polymeric material may be a second elastomeric material. In some embodiments of our method, the first elastomeric material and the second elastomeric material may be the same material. In other embodiments, the first elastomeric material may be different than the second elastomeric material. For example, the first elastomeric material may be a polybutylene terephtlatatel and the second elastomeric material may be a thermoplastic polyester elastomer.

Embodiments of our method may also include molding the one or more first and second chair components.

The first and second chair components may include various different chair components. For instance, the one or more first chair components may be a back skin and the one or more second chair components may be a back frame. As another example, the one or more first chair components may be a seat skin or seat membrane and the one or more second chair components may be a seat frame. As an additional example, the one or more first chair components may include an arm pad or armrest and the one or more second chair components may include an armrest support. As yet another example, the one or more first chair components may be a back frame and the one or more second chair components may be a seat frame, a chair base or a portion of a tilt mechanism.

Embodiments of our method may include numerous other steps. Preferably, our method also includes identifying desired colors for the one or more first chair components and one or more second chair components, checking a laser transmission rate for the first and second components and reformulating color pigments for the one or more first chair components, one or more second chair components, or both first and second chair components if the laser transmission rate is below a 25% rate to the at least one second chair component. It should be understood that the one or more first chair components and one or more second chair components may be samples used to develop chair parts or prototype parts.

Embodiments of our method may also include checking the weld strength of at least one weld joint formed between the first and second chair components.

We also provide a chair. In some embodiments of our invention, the chair may be a prototype chair or may be a well developed chair such as a finalized product or manufacturing quality chair. Embodiments of our chair may include a first component composed of a first polymeric material and a second component composed of a second polymeric material. The first component is laser welded to the second component. Preferably, the first component is opaque to the laser welding laser and the second component is translucent or substantially translucent to the laser welding laser. Most preferably, the laser welding laser transmission rate is at least 25% to the first component.

One or more fasteners may also be included to help attach the first component to the second component. Such fasteners may help strengthen the attachment between the components. In many embodiments of our chair, however, we prefer that no fasteners such as screws or bolts extend from the first component to the second component to help provide a desirable aesthetic effect to the attached chair components.

At least one of the first component and second component may include one or more color pigments or color additives such that the first and second components are configured to be greater than 5% to the first component and, most preferably, for a laser transmission rate of at least 25% to the first component.

Other details, objects, and advantages of the invention will become apparent as the following description of certain present preferred embodiments thereof and certain present preferred methods of practicing the same proceeds.

### BRIEF DESCRIPTION OF THE DRAWINGS

Present preferred embodiments of chairs and the laser welding chair component method are shown in the accompanying drawings in which:

FIG. 1 is a flow chart illustrating a first present preferred method of identifying components that may be laser welded together.

FIG. 2A is a perspective view of a first present preferred chair component laser welded to a second present preferred chair component.

FIG. 2B is a perspective view of a third present preferred chair component and fourth present preferred chair component laser welded to a fifth present preferred chair component.

FIG. 3 is a perspective view of a first present preferred embodiment of a chair that has a back skin component laser welded to a back frame component.

FIG. 4 is a perspective view of a present preferred seat skin component laser welded to a present preferred seat frame component of a chair.

### DETAILED DESCRIPTION OF PRESENT PREFERRED EMBODIMENTS

Chair components may be composed of plastics, such as for example, thermoplastic materials or elastomers. Preferably, such components are composed of Hytrel®, which is a polyester elastomer manufactured by E. I. du Pont de Nemours and Company. Of course, the components could be made by other plastics, such as, for example, polybutylene terephtalate (“PBT”). Different components that are to be welded together may also be made of different thermoplastic materials. For example, a back frame could be composed of PBT and a back skin to be attached to the back frame could be composed of Hytrel® material. Preferably, such components are welded together by laser welding. Such laser welding, however, preferably does not affect the aesthetic effect such components may provide once the components are assembled together to form a particular structure, such as a chair.

Laser welding of such components has been found to be effective for attaching different chair components to each other. Preferably, a viewable portion of the components being attached to each other will not be affected by the laser welding such that the aesthetic effect provided by the welded components is not negatively affected by the laser welding.

In one embodiment of a present preferred method of laser welding, two or more chair components are laser welded together. A first chair component should be transparent to the laser such that the first component will not absorb a significant amount of heat from the laser during the welding, but is also preferably opaque to the human eye so it can be easily seen by a potential user and provide a desired aesthetic effect. A second chair component should be opaque to the laser so that the second component absorbs the heat from the laser such that the heat created at a joint between the first and second components will create a welded joint. It has been determined that the laser weld joint that is formed from laser welding the first component and the second component is stronger than the parent material of either the first or second component.

It has been determined that the color of each component being welded together is important to laser welding the components so that one or more components that are opaque to the laser and the other one or more components that are transparent, or at least substantially transparent, to the laser are effectively welded together. Such color combinations preferably permit at least a 25% laser transmission rate to the laser opaque component. If the laser transmission rate is less than 25%, the laser welding of the components have been found to be substantially less effective and, in some cases, do not effectively weld the components together. For instance, as may be appreciated from Table 1, which is provide below, a laser transmission rate of 5% or less has been found to fail to adequately weld two components together. If the laser transmission rate is found to be less than 25%, it is preferred that the color formulations of the components be adjusted to increase the laser transmission rate to at least 25%. We prefer to use a laser made by Leister Technologies, LLC, such as the Globo head laser or a Novolas welding system, but other lasers may also be used to laser weld the components together.

It is contemplated that pressure may be applied to the components being welded together. For instance, a clamping mechanism or press may apply a pressure to the components during welding or after the welding to help join the materials being welded.

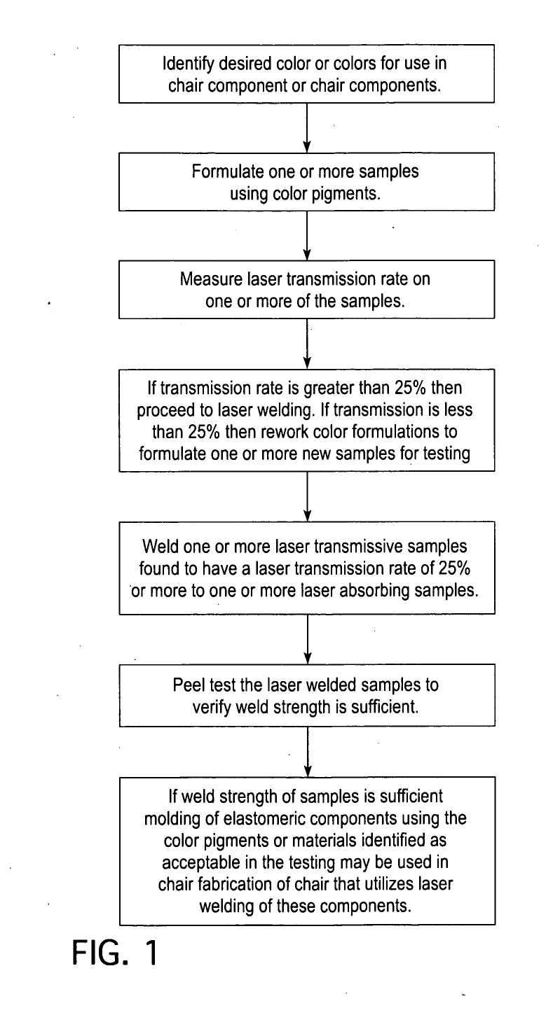

A present preferred method for determining what colored components may be properly laser welded together is shown in FIG. 1. Preferably required colors for the components are identified by a design team or designer. Test samples composed of a desirable material, such as an elastomeric material, may then be formed using one or more color pigments or color additives. The laser transmission rate on test samples should then be measured. If the laser transmission rate is greater than 25%, then components composed of those colors and that material may be successfully welded together to form a strong weld joint that may survive the life of a chair. If the laser transmission rate is less than 25%, then the color formulations for the samples can be reworked to improve the laser transmission rate. Each sample may then be laser welded to a laser absorbing sample. Preferably, the weld lines are of equal length and are two millimeters thick to ensure the weld is a strong weld. The welded samples should then be peel tested. If the peel test shows that the weld strength is sufficient to meet chair design specifications, then prototype parts may be made using the color pigments or color additives identified as providing a material that is sufficiently laser transmissive. Preferably, prototype components are made and laser welded to verify the testing results were accurate. If testing of the prototype components shows the welded components meet design criteria, then the components may be utilized in chair fabrication.

Of course, the prototype components may not be created or used to verify that the laser welded components may be used in chair fabrication in alternative embodiments of our method. Instead, if particular samples are identified as being appropriate for laser welding, a chair may include components composed of the material found acceptable in the samples for use in fabrication of a chair utilizing laser welding as a fastening mechanism for those components.

It should be understood that Leister Technologies, LLC has pioneered laser welding for applications in non-analogous fields. For instance, laser welding has been used to for sensor components, electronic packages, block gauges, and vehicle tail lamps. However, chairs and chair components provide a much greater degree of difficulty for welding and fastening components than tail lamps, electronic packaging and vehicle lamps developed by Leister Technologies LLC. For instance, chair components can undergo significant stresses of various different vectors and have significantly and substantially different stress and strain problems that a connection of components must experience. This is particularly true of back frame and back skin components undergoing back recline or a seat frame and seat skin components supporting a seated user that moves while sitting.

Indeed, we believe that design considerations related to sensor components, electronic packages, block gauges, and vehicle tail lamps have never been considered relevant to or considered in the development of a chair. The design considerations for such sensor components, electronic packages, block gauges, and vehicle tail lamps are drastically different than the considerations for chair design. This is particularly true in view of the drastically different environments and wear experienced by these incredibly different devices. For instance, the stress and strain chair components undergo during the life of a chair and the fact that any welding of sensor components, electronic packages, block gauges, and a vehicle tail lamps would be considered to have very different and less demanding needs relative to requirements for chair components, such as back or seat skins and back or seat frames used in a chair design. Indeed, no one of ordinary skill in the art of chairs is believed to have even contemplated, let alone tried, to pursue use of laser welding or the methods disclosed herein prior to our endeavors due at least in part to these significant differences and the non-analogous nature of the previous uses relative to chairs, chair fabrication and chair design. Testing results, which are provided below, also show that modifying the laser welding used in non-analogous field cannot be easily or obviously adapted to provide for a suitable attachment of chair components.

Testing was conducted to evaluate various different color combinations of components composed of Hytrel® material, which is a thermoplastic polyester elastomer, to determine which color combinations provide an effective laser transmission rate. The results of this testing is provided in the below Table 1.

TABLE 1
Summary of Weld Testing Results

| | Crastin 15% It grey | Crastin 15% Charcoal | 6356 Igt grey | 6356 Charcoal |
|---|---|---|---|---|
| Hytrel ® material | NB72620119 | NB74620118 | NE72620088 | NE74620087 |
| 4069 light grey UV | Did not weld. 5% | Did not weld. 5% | Did not weld. 5% | Did not weld. 5% transmission |
| NE71620085 | transmission measured | transmission measured | transmission measured | measured |
| 4069 orange UV | Good weld with 3 lines | Good weld with 3 lines | Good weld with 3 lines | Good weld with 3 lines |
| NE21620034 | 25% transmission | 25% transmission | 25% transmission | 25% transmission |
| 4069 blue UV | Good weld with 3 lines | Good weld with 3 lines | Good weld with 3 lines | Good weld with 3 lines |
| NE52620117 | 25% transmission | 25% transmission | 25% transmission | 25% transmission |
| 4069 Brown UV | Good weld with 3 lines | Good weld with 3 lines | Good weld with 3 lines | Good weld with 3 lines |
| NE83620048, | 25% transmission | 25% transmission | 25% transmission | 25% transmission |
| 4069 dark Grey UV | Did not weld. 5% | Did not weld. 5% | Did not weld. 5% | Did not weld. 5% transmission |
| NE74620086 | transmission measured | transmission measured | transmission measured | measured |
| 4069 light grey UV | Good weld with 3 lines | Good weld with 3 lines | | |
| NE71620091 | 30% transmission | 30% transmission | | |
| 4069 dark Grey UV | Good weld with 3 lines | Good weld with 3 lines | | |
| NE74620090 | 32% transmission | 32% transmission | | |
| 4069 Black UV | | Good weld with 3 lines | | |
| NE91620158 | | 28% transmission | | |
| 4069 Dolphin | | Good weld with 3 lines | | |
| NE74620093 | | 27% transmission | | |
| 4060 Pacific | | Good weld with 3 lines | | |
| NE54620122 | | 32% transmission | | |
| 4069 Earth | | Good weld with 3 lines | | |
| NE82620049 | | 32% transmission | | |

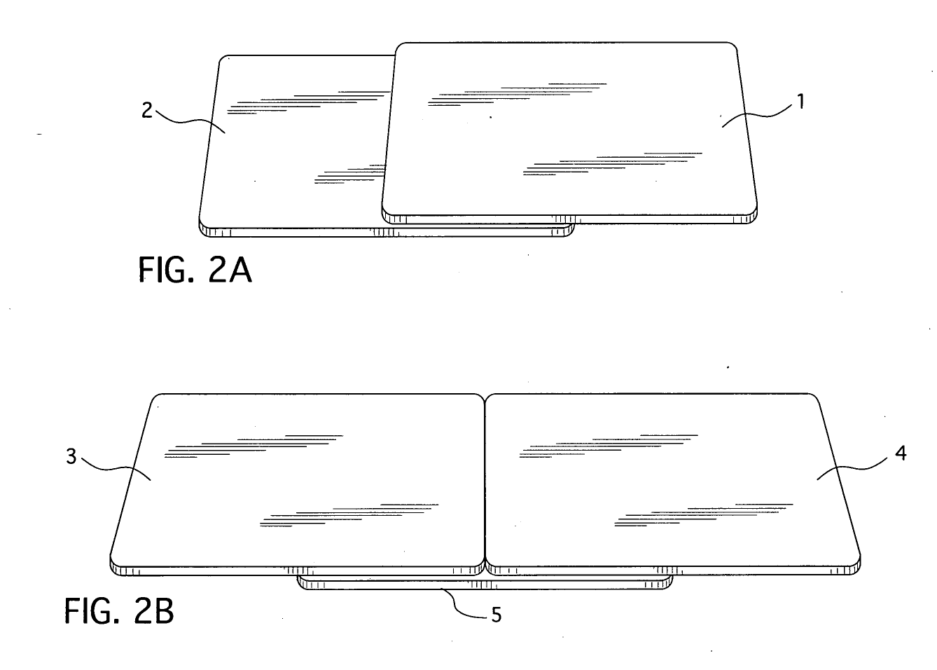

It is contemplated that various other color combinations of laser translucent components and laser absorbent, or laser opaque, components may be found to provide an effective laser transmission rate. Further, as can be appreciated from FIGS. 2A and 2B, different colored components may be effectively laser welded together. For instance, a blue component 1 may be welded to a grey component 2. As another example, an orange component 3 and a red component 4 may be welded to a dark grey component 5.

Testing of the strength of the welds was also conducted. Such testing secured two welded components to a Tinius Olsen Machine and then exposed those parts to gradual force until the parts yielded. The Tinius Olson Setting was fast speed, 10 inches per minute travel.

The conducted testing showed that the laser welded components only broke after being exposed to a force of between 750 and 789 pounds (lbf). If other fastening mechanisms were included, such as hooks, the strength of the attached components was found to be between 850 lbf and 1,000 lbf. In contrast, using only a typical fastening mechanism, such as hook and eyelet arrangement, samples were found to only have a connection strength of 450 lbf, 600 lbf and 670 lbf prior to breaking. Thus, the laser welding was found to be at least over 11% stronger than a conventional method of connecting the components.

Testing was also conducted to verify that the welded components were sufficiently durable. The conducted testing involved securing a sample part formed by laser welding two components composed of Hytrel® (grade 4069) material together to a testing device to prevent any movement during testing. An air cylinder was then positioned to apply a vertically directed force that flexed the sample back and forth at a rate of 30 cycles per minute. The testing was scheduled for 1,000,000 cycles of each sample. Each sample was checked periodically after every 100,000 cycles had been run until the testing was completed. After 1,000,000 cycles, no damage or other observations were found to exist in the welded components.

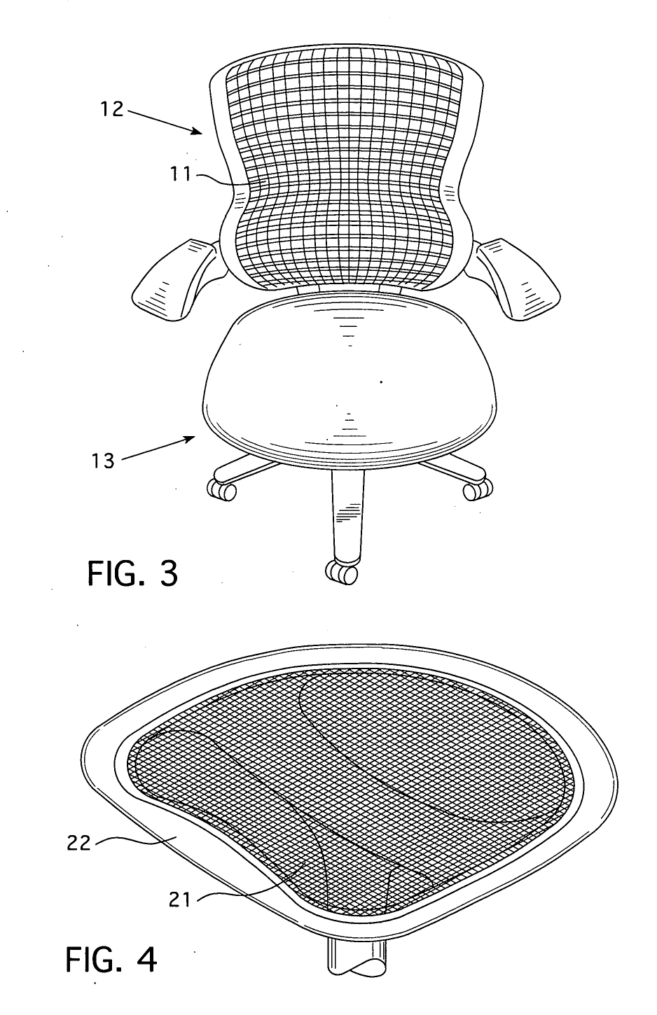

It should be appreciated that the two or more components that are laser welded together using the present preferred methods discussed above can include various different components. For example, as shown in FIG. 3, the components could include a back skin component 11 and a back frame component 12 sized and configured for attachment to a chair 13. The back skin component 11 is preferably composed of material that is translucent, or at least substantially translucent, to the laser and the back frame component 12 is preferably composed of material that is opaque to the laser.

As another example, the components may include a seat skin component 21 that is laser welded to a seat frame component 22 or chair base component, as may be seen in FIG. 4. The seat skin component 21 is preferably composed of material that is translucent, or at least substantially translucent, to the laser and the back frame component 22 is preferably composed of material that is opaque to the laser.

Of course, embodiments of our method may also be used to fasten other components together. For instance, it is contemplated that an arm pad may be laser welded to an armrest support or arm pad support. As another example, it is contemplated that a back frame may be laser welded to a seat frame or a chair base component. As yet another example, it is contemplated that a seat frame component may be laser welded to a chair base component or a tilt mechanism component.

It should be understood that the use of laser welding of laser translucent components and laser opaque components permits the manufacture and fabrication of chairs formed from such components to occur much more quickly and easily. For example, manufacturing processes can be designed with fewer limitations than other welding and fabrication methods known to those skilled in the art because lasers that conduct the laser welding can pass through the components composed of laser translucent, or at least substantially translucent, components without damaging or otherwise negatively affecting those components. It is contemplated that significant cost savings and manufacturing design flexibility can be achieved with the present preferred methods discussed herein.

While certain present preferred embodiments of the laser welding method and chairs and chair components formed by using such embodiments of our method have been shown and described above, it is to be distinctly understood that the invention is not limited thereto but may be otherwise variously embodied and practiced within the scope of the following claims.

What is claimed is:

1. A method of laser welding chair components together comprising:
selecting at least one first chair component comprised of a first polymeric material that is at least substantially translucent to a laser;
selecting at least one second chair component comprised of a second polymeric material that is opaque to the laser such that the at least one second chair component will absorb at least a portion of the heat or energy provided by the laser; and
laser welding the at least one first chair component to the at least one second chair component.

2. The method of claim 1 wherein the at least one first chair component and the at lest one second chair component are configured such that the laser welding has a laser transmission rate of at least 25% to the at least one second chair component.

3. The method of claim 1 wherein the at least one first chair component and the at lest one second chair component are configured such that the laser welding has a laser transmission rate that is greater than 5% to the at least one second chair component.

4. The method of claim 1 wherein the first polymeric material is also the second polymeric material.

5. The method of claim 4 wherein the first polymeric material is different than the second polymeric material.

6. The method of claim 3 wherein the first polymeric material is a first elastomeric martial and the second polymeric material is also the first elastomeric material.

7. The method of claim 4 wherein the first polymeric material is comprised of polybutylene terephtlatatel and the second polymeric material is comprised of a thermoplastic polyester elastomer.

8. The method of claim 1 further wherein the at least one first chair component is a back skin and the at least one second chair component is a back frame.

9. The method of claim 1 further wherein the at least one first chair component is a seat skin and the at least one second chair component is a seat frame.

10. The method of claim 1 further comprising identifying desired colors for the at least one first chair component and the at least one second chair component, checking a laser transmission rate for the at least one first chair component and at least one second chair component and reformulating color pigments for at least one of the at least one first chair component and at least one second chair component if the laser transmission rate is below a 25% laser transmission rate to the at least one second chair component.

11. The method of claim 10 wherein the at least one first chair component is a first sample and the at least one second chair component is a second sample.

12. The method of claim 1 further comprising checking for weld strength of at least one weld joint formed between the at least one first chair component and at least one second chair component.

13. The method of claim 1 further comprising molding the at least one first chair component and molding the at least one second chair component.

14. The method of claim 1 further comprising engaging the at least one first chair component with the at least one second chair component for laser welding the at least one first chair component to the at least one second chair component.

15. A chair comprising:
a first component comprised of a polymeric material; and
a second component comprised of a polymeric material, the first component laser welded to the second component.

16. The chair of claim 15 wherein the first component is opaque to a laser welding laser and the second component is translucent or substantially translucent to the laser welding laser and wherein the first component and second component are configured such that laser welding of the first component to the second component has a laser transmission rate of at least 25% to the first component.

17. The chair of claim 16 further comprising at least one fastener that helps attach the first component to the second component.

18. The chair of claim 16 wherein the there is no screw or bolt extending from the first chair component to the second chair component.

19. The chair of claim 16 wherein the first polymeric material is an elastomeric material and the second polymeric material is an elastomeric material.

20. The chair of claim 19 wherein the elastomeric material of the first polymeric material is also the elastomeric material of the second polymeric material.

21. The chair of claim 20 wherein at least one of the first polymeric material and the second polymeric material is a thermoplastic polyester elastomer.

22. The chair of claim 16 wherein at least one of the first component and second is also comprised of at least one color pigment or at least one color additive such that the first component and second component are configured for a laser transmission rate of at least 25% to the first component.

23. The chair of claim 15 wherein the first component and second component are configured such that laser welding of the first component to the second component has a laser transmission rate that is greater than 5% to the first component.

24. The chair of claim 15 wherein the first component and second component are configured such that laser welding of the first component to the second component has a laser transmission rate of at least 25% to the first component.
